(19) United States
(12) Patent Application Publication
(10) Pub. No.: US 2009/0180938 A1
(43) Pub. Date: Jul. 16, 2009

(54) WASTE LIQUID PROCESSING DEVICE

(75) Inventors: Hideo Noro, Kamiina-gun (JP); Toshio Kumagai, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/355,295

(22) Filed: Jan. 16, 2009

(30) Foreign Application Priority Data
Jan. 16, 2008 (JP) 2008-006518

(51) Int. Cl. B01J 19/08

(52) U.S. Cl. 422/186.3

(57) ABSTRACT

Provided is a waste liquid processing device including: a carrier transporting a waste liquid attached thereto; an attachment portion attaching a liquid cured by irradiation of energy rays to the carrier; an irradiation portion irradiating the energy rays to the waste liquid attached to the carrier by the attachment portion so as to cure the waste liquid; and a removal portion removing the waste liquid cured by the irradiation portion from the carrier.

### CROSS-REFERENCE TO RELATED APPLICATIONS

This application claims priority under the Paris Convention based on Japanese Patent Application No. 2008-006518 filed on Jan. 16, 2008.

### BACKGROUND

1. Technical Field

The present invention relates to a waste liquid processing device of an energy ray-curable liquid such as an energy ray-curable ink which is cured by irradiation of energy rays such as ultraviolet (UV) rays, and more particularly, a waste liquid processing device applicable to a liquid ejecting apparatus such as an ink jet recording apparatus for discharging ink droplets from nozzles in correspondence with print data so as to form dots on a recording medium.

2. Related Art

As a liquid ejecting apparatus for ejecting a liquid on a target, an ink jet recording apparatus for ejecting an ink on a recording sheet so as to perform printing is known. Since a recording head of the ink jet recording apparatus ejects an ink pressurized in a pressure generation chamber from nozzles on a recording sheet as ink droplets so as to perform printing, an ejection failure state is generated by the increase of ink viscosity due to the vaporization of a solvent from nozzle openings, the solidification of the ink, the attachment of dust, and the mixture of air bubbles. Thus, a printing failure occurs.

Therefore, the ink jet recording apparatus includes a capping portion for sealing the nozzle openings of the recording head when printing is not performed and a wiping member for cleaning a nozzle forming surface if necessary. This capping portion has a cover function for preventing the ink of the nozzle openings from being dried and a function for solving the clogging of the nozzle openings by sealing the nozzle forming surface by the capping portion and sucking and discharging the ink from the nozzle openings by the negative pressure of a suction pump when the nozzle openings are clogged.

The process of forcedly sucking and discharging the ink in order to solve the clogging of the recording head is called a cleaning operation and is performed, for example, when printing is resumed after the long-term stop of the recording apparatus or when a user recognizes a printing failure and operates a cleaning switch. In addition, the operation for wiping the nozzle forming surface of the recording head is performed by the wiping member made of an elastic plate such as rubber after discharging the ink from the recording head.

In addition to the cleaning operation, as the operation for solving the clogging of the recording head, a flushing operation for inputting an ink droplet ejection signal to a driving element of the recording head regardless of a printing signal and discharging the ink to a flushing reception unit is performed.

In addition, a waste liquid from the recording head, which is contained in the flushing reception unit or the capping portion by the cleaning operation or the flushing operation, can be dumped into a waste liquid tank. In the waste liquid tank, a waste liquid absorption material generally made of a porous material is received and a waste liquid is maintained as being absorbed by the waste liquid absorption material.

Meanwhile, an ink jet recording method includes an UV ink jet method. The UV ink jet method is a recording method of attaching an energy ray-curable ink, which is cured by the irradiation of energy rays such as ultraviolet (UV) rays, on a recording medium and then curing the energy ray-curable ink by irradiating the energy rays onto the recording medium so as to perform printing.

In the recording apparatus of the UV ink jet method, an apparatus for introducing a waste ink discharged by a cleaning operation or a flushing operation into a waste ink bottle, in which an absorber for absorbing an ink is charged, and irradiating ultraviolet rays to a waste ink absorbed in the absorber of the transparent waste ink bottle is suggested (JP-A-2004-155047).

In addition, an apparatus for curing an ink ejected to a flushing reception unit by a flushing operation by irradiating ultraviolet rays onto the flushing reception unit and scraping the ink cured on the flushing reception unit by a cleaning unit is suggested (JP-A-2007-130784).

However, in the apparatus described in JP-A-2004-155047, since the absorber or the cured liquid is not necessarily transparent although the waste liquid container is transparent and the ultraviolet rays are irradiated in a state in which the waste ink is absorbed in the absorber, the ink is rapidly cured in a portion close to the outside of the transparent waste liquid container because the flow of the ultraviolet ray is excellent, but the ink is left in an uncured state at the inside of the waste liquid container because the ultraviolet rays are hard to reach the inside of the waste liquid container.

In many cases, the ultraviolet curable liquid includes materials having skin irritation, has strong irritating odor, and, if it is in an uncured state, the ultraviolet curable liquid has a bad influence on the human body when directly being brought into contact with the skin of a person. In addition, a working environment is bad due to irritating odor. However, if the ultraviolet curable liquid is cured, the ultraviolet curable liquid becomes harmless and irritating odor is suppressed. Accordingly, if the ultraviolet curable liquid is left in the uncured state like the apparatus of JP-A-2004-155047, the stability or the comfort of the working environment cannot be ensured when the waste liquid container is collected and an incineration treatment is performed.

If the liquid is cured in a state of being absorbed in the absorber, the next collected liquid is hard to be absorbed in the absorber and thus the waste liquid cannot be collected although a surplus capacity exists in the collection amount of the waste liquid container. In this case, since a deviation occurs by the absorption state or the curing state of the waste liquid, the life span of the waste liquid tank is not constant and replacement timing cannot be adequately informed to a user.

In the apparatus described in JP-A-2007-130784, the ink ejected to the flushing reception unit can be cured with certainty, but the process of curing the ink contained in the waste liquid tank by cleaning is not prepared and the above-described problem is not solved.

In the apparatus described in JP-A-2007-130784, the ink is ejected to a flushing reception surface and is cured by the ultraviolet light and the cured ink is scraped by rubbing the flushing reception surface with a wiper so as to be discharged from a discharge port provided in the flushing reception surface.

However, in the apparatus described in JP-A-2007-130784, the process of ejecting the ink to the flushing reception surface, the process of curing the ejected ink by the ultraviolet light and the process of scraping the cured ink by rubbing with the wiper are all performed on the flushing reception surface. Since the ejection, the curing and the scraping of the ink are sequentially performed on the same flushing reception surface, waste liquid processing efficiency is extremely bad and has an influence on printing efficiency. In addition, if the cured ink on the flushing reception surface facing an ultraviolet light source is scraped by wiping, fragments of the cured ink enter the discharge port and fly, thereby staining the periphery. In particular, if the light irradiation surface of the ultraviolet light source facing the flushing reception surface is stained, irradiation efficiency deteriorates and the curing time is gradually increased when the ultraviolet light source is used over a long period. In addition, in this apparatus, since the ink ejected to the flushing reception surface does not have a uniform thickness, a deviation occurs in the curing state if the ink is cured by the ultraviolet light, and the ink cannot be completely removed by wiping if the uncured ink is left. The uncured ink flies such that the light irradiation surface is susceptible to be stained. In order to solve this problem, the ultraviolet light irradiation time should be excessively increased. Thus, waste liquid processing efficiency is inferior and energy is wasted.

### SUMMARY

An advantage of some aspects of the invention is that it provides a waste liquid processing device capable of converting a liquid into a harmless solid with certainty, collecting the solid and stably and easily performing a waste liquid process.

According to an aspect of the invention, there is provided a waste liquid processing device including: a carrier transporting a waste liquid attached thereto; an attachment portion attaching a liquid cured by irradiation of energy rays to the carrier; an irradiation portion irradiating the energy rays to the waste liquid attached to the carrier by the attachment portion so as to cure the waste liquid; and a removal portion removing the waste liquid cured by the irradiation portion from the carrier.

The waste liquid processing device of the invention attaches the liquid cured by the irradiation of the energy rays to the carrier, irradiates the energy rays to the waste liquid attached to the carrier by the attachment portion so as to cure the waste liquid, and removes the waste liquid cured by the irradiation unit from the carrier. In order to irradiate the energy rays to the waste liquid attached to the carrier so as to cure the waste liquid and remove the cured waste liquid from the carrier, the waste liquid which is left in a state of being uncured is not substantially present and thus the stability or the comfort of the work in the collecting and processing of the waste liquid can be ensured. In addition, since the waste liquid is completely cured, the deviation does not occur in the collection amount by the absorption state or the curing state of the waste liquid and thus the replacement timing of the collection portion can be adequately informed to a user.

In the invention, if the attachment operation using the attachment portion, the irradiation using the irradiation portion and the removal operation using the removal portion are continuously performed by a transportation operation of the carrier, since the attachment operation, the irradiation and the removal operation are continuously performed by the continuous transportation operation of the carrier so as to perform the waste liquid processing, the waste liquid can be completely cured with very high processing efficiency.

In the invention, an attachment unit including the attachment portion and an irradiation unit including the irradiation portion are provided at different places. Thus, although the droplets of the waste liquid are generated in the attachment unit, since the irradiation unit is provided at the different place, an irradiation surface is hard to be contaminated, irradiation efficiency can be prevented from deteriorating, and stable curing efficiency can be maintained for a long period of time.

In the invention, an irradiation unit including the irradiation portion and a removal unit including the removal portion are provided at different places. Thus, although the fragment of the cured waste liquid removed in the removal unit flies, since the irradiation unit is provided at the different place, the irradiation surface is hard to be contaminated, irradiation efficiency can be prevented from deteriorating, and stable curing efficiency can be maintained for a long period of time.

In addition, in this case, the attachment unit and the removal unit are provided at different places. Thus, although the fragment of the cured waste liquid removed in the removal unit flies, since the attachment unit is provided at the different place, the fragment of the cured waste liquid can be prevented from being attached to the carrier again or the fragment of the cured waste liquid can be prevented from being mixed into a waste liquid supply system so as to cause a problem in the supply of the waste liquid.

In the invention, if the attachment portion is configured to attach the waste liquid onto the carrier by a substantially uniform thickness, the deviation does not occur in the curing state of the waste liquid by the irradiation of the energy rays and the contamination due to removal remainder of the removal portion or the flying of the uncured waste liquid does not occur. In addition, the irradiation time of the energy rays does not unnecessarily need to be extended and energy waste does not occur.

In the invention, if a collection portion collecting the cured waste liquid removed from the carrier by the removal portion is provided in a removal unit including the removal portion, the removed cured waste liquid can be sequentially collected and the treatment of the removed cured waste liquid becomes facilitated. In addition, since the waste liquid which is completely cured is collected, the deviation does not occur in the collection amount by the absorption state or the curing state of the waste liquid and the replacement timing of the collection portion can be adequately informed to the user.

In the invention, if the carrier is subjected to a transportation operation from the attachment unit to the removal unit through the irradiation unit, is returned to the attachment unit, and is subjected to the same transportation operation, the attachment operation, the irradiation, and the removal operation are continuously performed to perform the waste liquid processing by the repetition of the transportation operation of the carrier, the waste liquid can be completely cured with very high processing efficiency.

In the invention, if a waste liquid attachment surface of the carrier is formed of a material to which the cured waste liquid is not adhered, the removal remainder is not present on the carrier after the removal of the cured waste liquid by the removal portion and the waste liquid is prevented from being laminated on the cured waste liquid in advance so as to become agglomerate when the attachment operation to the carrier is next performed.

### BRIEF DESCRIPTION OF THE DRAWINGS

The invention will be described with reference to the accompanying drawings, wherein like numbers reference like elements.

FIG. 1 is a view showing the schematic configuration of a recording apparatus according to the invention.

FIG. 2 is a view showing the configuration of a waste liquid processing device according to the present embodiment.

FIG. 3 is a view showing a second embodiment.

FIG. 4 is a view showing a third embodiment.

FIG. 5 is a view showing a fourth embodiment.

### DESCRIPTION OF EXEMPLARY EMBODIMENTS

Next, embodiments of the invention will be described in detail.

Hereinafter, an embodiment in which a waste liquid processing device of the invention is applied to an ink jet recording apparatus as a liquid ejecting apparatus will be described with reference to the accompanying drawings.

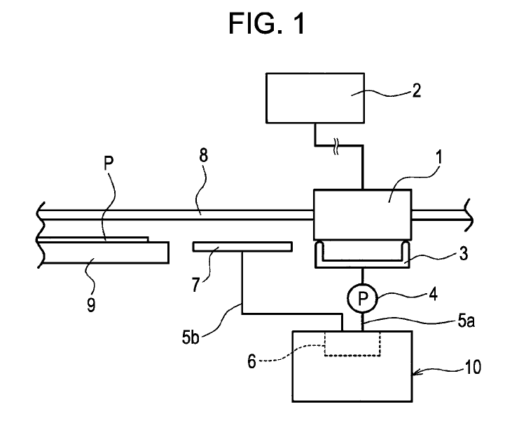

FIG. 1 is a view showing the configuration of main portions of an ink jet recording apparatus according to the invention.

In the drawing, a reference numeral 1 is an ejection head 1 which is mounted in a carriage (not shown) and is scanned and moved along a guide bar 8. The ejection head 1 receives an ink from an ink cartridge 2 as an ink tank and ejects ink droplets from nozzles to recording paper P which is a target on a platen 9 so as to perform recording.

In addition, a reference numeral 3 is a capping portion 3 arranged outside a recording area. This capping portion 3 is connected to a suction pump 4 for applying negative pressure to an internal space of the capping portion 3. The capping portion 3 functions as a cover for sealing a nozzle forming surface of the ejection head 1 during an idle period of the recording apparatus and preventing the nozzles from being dried and function as a cleaning unit for applying negative pressure from the suction pump 4 to the ejection head 1 so as to suck and discharge the ink from the ejection head 1.

By the above-described configuration, when the ink cartridge 2 is replaced or the nozzles of the ejection head 1 are clogged, upon start-up after being left for a long period of time, the nozzle forming surface of the ejection head 1 is capped by the capping portion 3 and is sucked by the suction pump 4 such that the ink is forcedly sucked and discharged, and the thickened ink or air bubbles in the ejection head 1 are sucked and discharged so as to maintain the ejection characteristics of the ejection head 1.

In addition, a reference numeral 7 is a flushing reception unit 7 arranged outside the recording area. The flushing reception unit 7 inputs an ink droplet ejection signal, which is unrelated to a printing signal, to a driving element of the ejection head 1 and receives the ink droplets ejected by a flushing operation for recovering the clogging of the ejection head 1, at a predetermined timing during a printing operation or a predetermined timing such as when power is turned on.

In the suction operation, the ink discharged from an ink discharge passage 5a by the suction of the suction pump 4 is introduced into a waste liquid tank 6. In addition, the ink ejected to the flushing reception unit 7 by the flushing operation is also introduced from an ink discharge passage 5b into the waste liquid tank 6. The waste liquid introduced into the waste liquid tank 6 is cured by a waste liquid processing device 10 of the invention.

In this example, as the ink, an energy ray-curable liquid such as an energy ray-curable ink which is cured by the irradiation of energy rays such as ultraviolet (UV) rays is used. For example, an ultraviolet curable ink is used and includes, for example, ultraviolet curable resin (5 to 10%), pigment (5 to 10%), an additive agent for performing stable printing by ink jet (about 20%) and water (60 to 70%).

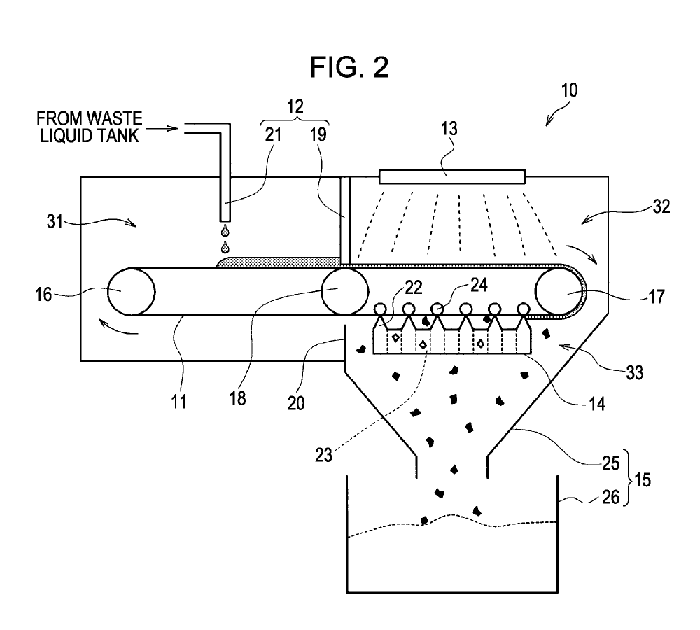

FIG. 2 is a view showing the configuration of the waste liquid processing device 10.

This waste liquid processing device 10 includes a conveyor 11 as a carrier for attaching and transporting a waste liquid, a coating device 12 as an attaching portion for attaching the liquid cured by the irradiation of the energy rays to the conveyor 11, an irradiation portion 13 for irradiating the energy rays to the waste liquid attached to the conveyor 11 by the coating device 12 so as to cure the waste liquid, and a removal portion 14 for removing the cured waste liquid cured by the irradiation portion 13 from the conveyor 11.

In more detail, in this example, the conveyor 11 has an endless belt shape so as to be wound on a driving roll 16 and a driven roll 17 located on both ends thereof. An attachment unit 31 which is a space having the coating device 12 is provided at the upper side of the driving roll 16 of the conveyor 11, an irradiation unit 32 which is a space having the irradiation portion 13 is provided at the upper side of the driven roll 17, and a removal unit 33 which is a space having the removal portion 14 is provided at the lower side of the driven roll 17. The attachment unit 31, the irradiation unit 32 and the removal unit 33 are provided at different places.

The attachment unit 31 and the irradiation unit 32 are partitioned by a coating member 19 functioning as a partitioning member. In addition, the irradiation unit 32 and the removal unit 33 are partitioned by the wound conveyor 11 functioning as a partitioning member, and the removal unit 33 and the attachment unit 31 are partitioned by the wound conveyor 11 functioning as a partitioning member and a partition wall 20. The attachment unit 31, the irradiation unit 32 and the removal unit 33 exist as substantially partitioned spaces.

The attachment portion of the attachment unit 31 includes a waste liquid supply unit 21 for supplying the waste liquid from the waste liquid tank 6 and a coating member 19 for attaching the supplied waste liquid on the surface of the conveyor 11 by a substantially uniform thickness. The waste liquid is supplied from the waste liquid supply unit 21 onto the conveyor 11 at a predetermined flow rate. The lower end of coating member 19 is positioned above the surface of the conveyor 11 in a state of maintaining a predetermined clearance therebetween. At a position corresponding to the lower end of the coating member 19, a support roll 18 for supporting the conveyor 11 from the bottom thereof such that the clearance between the lower end of the coating member 19 and the surface of the conveyor 11 is constantly maintained is arranged. Accordingly, the waste liquid supplied onto the conveyor 11 is coated by a predetermined thickness by the clearance between the surface of the conveyor 11 and the lower end of the coating member 19 when being transported in a right direction by the transportation operation of the conveyor 11 as shown in the figure.

The irradiation portion 13 of the irradiation unit 32 irradiates the ultraviolet (UV) rays to the waste liquid attached to the surface of the conveyor 11 by the coating device 12 as the energy rays and cures the waste liquid. In more detail, for example, a light-emitting diode (LED) for emitting light in an ultraviolet band may be used. The waste liquid coated on the conveyor 11 by the coating device 12 by a predetermined thickness is cured by the irradiation of the energy rays when being transported in the right direction by the transportation operation of the conveyor 11. The light amount of the irradiation portion 13 is properly set according to the amount of waste liquid processed per time or the speed of the conveyor 11 as shown in the figure.

The conveyor 11 is configured to be turned by the driven roll 17 provided between the irradiation unit 32 and the removal unit 33. When being turned by the driven roll 17, crack occurs in a waste liquid layer cured on the conveyor 11 transported in a flat state such that the removal of the cured waste liquid is easily performed by the removal portion 14.

The removal unit 33 includes the removal portion 14 for removing the cured waste liquid cured by the irradiation portion 13 from the conveyor 11 and a collection portion 15 for collecting the cured waste liquid removed from the conveyor 11 by the removal portion 14.

In this example, the removal portion 14 includes a plurality of scraping claws 22 for scraping the waste liquid cured on the surface of the conveyor 11 and a through-hole 23 for passing fragment of the scrapped cured waste liquid. In addition, at a position corresponding to the removal portion 14, a plurality of support rolls 24 for supporting the conveyor 11 from the top thereof such that the pressing force of each of the scraping claws 22 of the removal portion 14 is not missed is arranged. Accordingly, for example, the removal portion 14 reciprocally vibrates in a traveling direction of the conveyor 11 or a direction perpendicular to the traveling direction such that the waste liquid cured on the surface of the conveyor 11 is scraped by the scraping claws 22.

The waste liquid attachment surface of the conveyor 11 is preferably made of a material to which the cured waste liquid is not adhered. For example, the waste liquid attachment surface is preferably coated with a fluorine-based resin material or a silicon-based resin.

In addition, the removal unit 33 including the removal portion 14 is preferably provided on the side to which the driving tension of the conveyor 11 endlessly wound on the driving roll 16 and the driven roll 17 by the driving roll 16 is applied. Accordingly, the scraping force of the removal portion 14 is efficiently applied to the conveyor 11 to which the driving tension is applied such that scraping is efficiently performed.

A hopper 25 for collecting the fragment of the removed cured waste liquid and the collection portion 15 having a collection tank 26 for collecting the fragment collected by the hopper 25 are provided below the removal portion 14. A portion of the fragment of the cured waste liquid scraped by the removal portion 14 is dropped through the through-hole 23, is collected by the hopper 25, and is collected to the collection tank 26.

In addition, the conveyor 11 is transported from the attachment unit 31 to the removal unit 33 through the irradiation unit 32, is returned to the attachment unit 31 and is subjected to the same transportation operation again, and the attachment operation using the coating device 12, the irradiation using the irradiation portion 13, and the removal operation using the removal portion 14 are continuously performed by the transportation operation of the conveyor 11.

As described above, the waste liquid processing device 10 of the embodiment attaches the liquid cured by the irradiation of the energy rays to the conveyor 11, irradiates the energy rays to the waste liquid attached to the conveyor 11 by the coating device 12 so as to cure the waste liquid, and removes the waste liquid cured by the irradiation portion 13 from the conveyor 11. In order to irradiate the energy rays to the waste liquid attached to the conveyor 11 so as to cure the waste liquid and remove the cured waste liquid from the conveyor 11, the waste liquid which is left in a state of being uncured is not substantially present and thus the stability or the comfort of the work in the collecting and process of the waste liquid can be ensured. In addition, since the waste liquid is completely cured, the deviation does not occur in the collection amount by the absorption state or the curing state of the waste liquid and thus the replacement timing of the collection portion can be adequately informed to a user.

In the case where the attachment operation using the coating device 12, the irradiation using the irradiation portion 13 and the removal operation using the removal portion 14 are continuously performed by the transportation operation of the conveyor 11, since the attachment operation, the irradiation and the removal operation are continuously performed by the continuous transportation operation of the conveyor 11 so as to perform the waste liquid processing, the waste liquid can be completely cured with very high processing efficiency.

The attachment unit 31 having the coating device 12 and the irradiation unit 32 having the irradiation portion 13 are provided at different places. Thus, although the droplets of the waste liquid are generated in the attachment unit 31, since the irradiation unit 32 is provided at the different place, an irradiation surface is hard to be contaminated, irradiation efficiency can be prevented from deteriorating, and stable curing efficiency can be maintained for a long period of time.

In addition, the irradiation unit 32 having the irradiation portion 13 and the removal unit 33 having the removal portion 14 are provided at different places. Thus, although the fragment of the cured waste liquid removed in the removal unit 33 flies, since the irradiation unit 32 is provided at the different place, the irradiation surface is hard to be contaminated, irradiation efficiency can be prevented from deteriorating, and stable curing efficiency can be maintained for a long period of time.

In addition, the attachment unit 31 and the removal unit 33 are provided at different places. Thus, although the fragment of the cured waste liquid removed in the removal unit 33 flies, since the attachment unit 31 is provided at the different place, the fragment of the cured waste liquid can be prevented from being attached to the conveyor 11 again or the fragment of the cured waste liquid can be prevented from being mixed into a waste liquid supply system so as to cause a problem in the supply of the waste liquid.

In addition, since the coating device 12 is configured such that the waste liquid is attached to the conveyor 11 by the substantially uniform thickness, the deviation does not occur in the curing state of the waste liquid by the irradiation of the energy rays and the contamination due to removal remainder of the removal portion 14 or the flying of the uncured waste liquid does not occur. In addition, the irradiation time of the energy rays does not unnecessarily need to be extended and energy waste does not occur.

In addition, since the collection portion 15 for collecting the cured waste liquid removed from the conveyor 11 by the removal portion 14 is provided in the removal unit 33 having the removal portion 14, the removed cured waste liquid can be sequentially collected and the treatment of the removed cured waste liquid becomes facilitated. In addition, since the waste liquid which is completely cured is collected, the deviation does not occur in the collection amount by the absorption state or the curing state of the waste liquid and the replacement timing of the collection tank 26 can be adequately informed to the user.

In addition, if the conveyor 11 is transported from the attachment unit 31 to the removal unit 33 through the irradiation unit 32, is returned to the attachment unit 31 and is subjected to the same transportation operation again, since the attachment operation, the irradiation, and the removal operation are continuously performed to perform the waste liquid processing by the repetition of the transportation operation of the conveyor 11, the waste liquid can be completely cured with very high processing efficiency.

In addition, since the waste liquid attachment surface of the conveyor 11 is made of a material to which the cured waste liquid is not adhered, the removal remainder is not present on the conveyor 11 after the removal of the cured waste liquid by the removal portion 14 and the waste liquid is prevented from being laminated on the cured waste liquid so as to become agglomerate in advance when the attachment operation to the conveyor 11 is next performed.

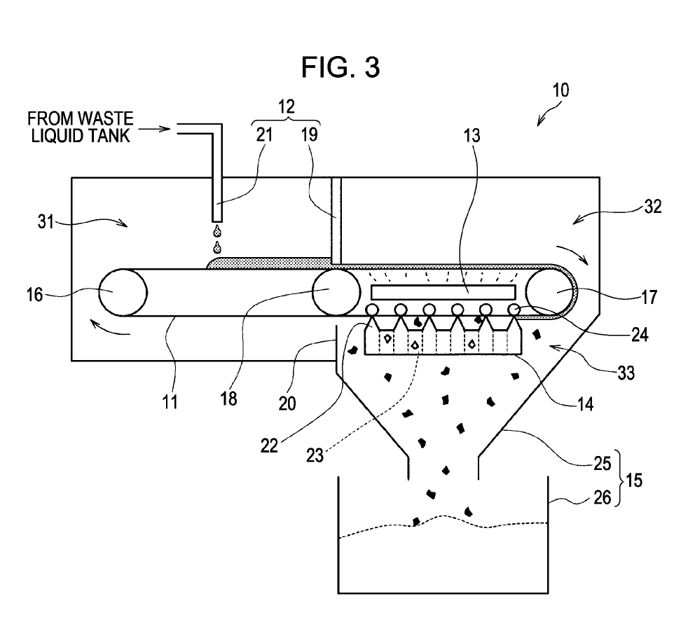

FIG. 3 is a view showing a waste liquid processing device 10 according to a second embodiment of the invention.

In this embodiment, the conveyor 11 is formed of a material which can passes the energy rays, such as a transparent member, and the irradiation unit 32 irradiates the energy rays from the inside of the conveyor, that is, the opposite side of the waste attachment surface, rather than the side of the waste liquid attachment surface of the conveyor 11. The other portions are equal to those of the first embodiment and the same portions are denoted by the same reference numerals. Even in this embodiment, the same effects as the above-described embodiment are obtained.

In addition, the irradiation unit 32 may irradiate the energy rays from the side of the waste liquid attachment surface of the conveyor 11 and irradiate the energy rays from the inside of the conveyor 11, that is, the opposite side of the waste attachment surface. Even in this embodiment, the same effects as the above-described embodiment are obtained.

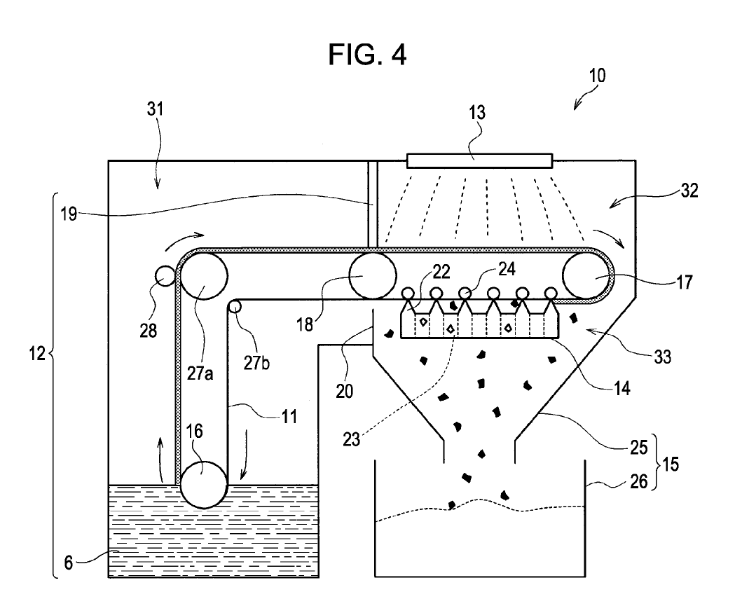

FIG. 4 is a view showing a waste liquid processing device 10 according to a third embodiment of the invention.

This embodiment is different from the above-described embodiment in the configuration of the coating device 12. That is, in this embodiment, the conveyor 11 is wound in a state in which the conveyor 11 on the side of the driving roll 16 is bent downward by bending rolls 27a and 27b. The waste liquid tank 6 is provided at the bottom of the attachment unit 31, and the conveyor 11 wound on the side of the driving roll 16 is immersed in the waste liquid contained in the waste liquid tank 6 such that the waste liquid is attached to the conveyor 11.

In addition, the waste liquid attached to the conveyor 11 immersed in the waste liquid of the waste liquid tank 6 is attached onto the conveyor 11 by a substantially uniform thickness by a coating roll 28 arranged at a predetermined clearance with the bending roll 27a. In addition, as a unit for uniformly attaching the waste liquid onto the conveyor 11, at least one of the coating member 19 and the coating roll 28 is used. The other portions are equal to those of the first embodiment and the same portions are denoted by the same reference numerals. Even in this embodiment, the same effects as the above-described embodiment are obtained.

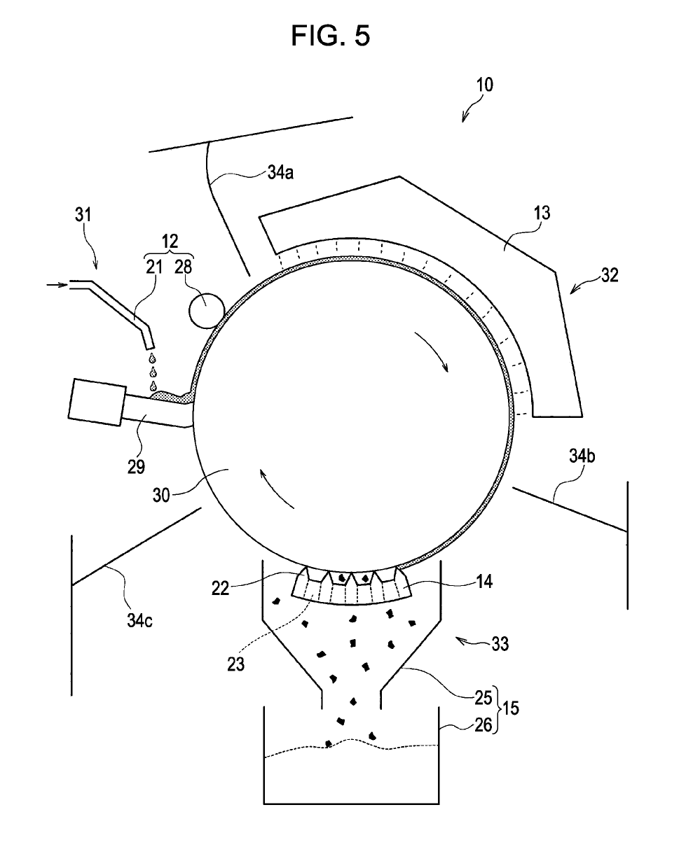

FIG. 5 is a view showing a waste liquid processing device 10 according to a fourth embodiment of the invention.

In this embodiment, as the carrier, a drum 30 is used instead of the conveyor 11. That is, for example, in this embodiment, an attachment unit 31 having a coating device 12 is provided on the left side of the drum 30 as shown in the figure, an irradiation unit 32 having an irradiation portion 13 is provided on the right side thereof, and a removal unit 33 having a removal portion 14 and a collection portion 15 is provided below the drum 30. The attachment unit 31, the irradiation unit 32 and the removal unit 33 are partitioned by partition walls 34a, 34b and 34c.

A blade 29 for receiving the waste liquid supplied from a waste liquid supply unit 21 is provided in the attachment unit 31. The blade 29 is formed of an elastic member such as rubber, the drum 30 rotates in a state in which the front end edge of the blade is in contact with the surface of the drum 30, and the waste liquid is received on the upper surface of the blade 29 so as not to flow downward.

The waste liquid supplied to the upper surface of the blade 29 is transported in a state of being attached to the surface of the drum 30 by the rotation of the drum 30. At the slightly downstream side of the blade 29 in the rotation direction of the drum 30, the coating roll 28 for coating the waste liquid attached to the surface of the drum 30 by the substantially uniform thickness is provided while maintaining a predetermined clearance with the surface of the drum 30.

The irradiation portion 13 for irradiating energy rays to the waste liquid attached to the surface of the drum 30 so as to cure the waste liquid is arranged in the irradiation unit 32. In addition, the removal portion 14 for scraping the waste liquid cured by the irradiation of the energy rays using the irradiation portion 13 from the surface of the drum 30 and the collection portion 15 for collecting the fragment of the removed cured waste liquid are provided in the removal unit 33.

In this example, the circumferential wall of the drum 30 may be formed of a member for transmitting the energy rays, such as a transparent body, and the irradiation portion 13 may irradiate the energy rays from the inside of the drum 30 to the circumferential wall of the drum 30. In addition, the energy rays may be irradiated from the inside and the outside of the drum 30. The other portions are equal to those of the first embodiment and the same portions are denoted by the same reference numerals. Even in this embodiment, the same effects as the above-described embodiment are obtained.

Although, in the above-described embodiments, the conveyor 11 and the drum 30 are used as the carrier, the invention is not limited to them. For example, a hard plate having an endless track shape or a chain conveyor using a chain may be used as the carrier of the invention.

Although, in the above-described embodiments, an LED for emitting light in an ultraviolet band is described as the irradiation portion 13, the invention is not limited to this. As the irradiation portion 13, for example, various types of energy ray irradiating units such as a metal halide lamp, a xenon lamp, a carbon arc lamp, a chemical lamp, a low-pressure mercury lamp, and a high-pressure mercury lamp may be used.

In the above-described embodiments, the ejection head 1 is applicable to a liquid ejecting apparatus using a piezoelectric vibrator or a liquid ejecting apparatus using a heating element, as a pressure generation element which is a driving element for ejecting a liquid.

In addition, a representative example of the liquid ejecting apparatus includes the above-described ink jet recording apparatus including an ink jet recording head for recording an image. The invention is, for example, applicable to various types of liquid ejecting apparatuses, such as an apparatus including a coloring material ejecting head used for manufacturing color filters of a liquid crystal display and the like; an apparatus including an electrode material (conductive paste) ejecting head used for forming electrodes of an organic EL display, a field emission display (FED) and the like; an apparatus including a bio-organic matter ejecting head used for manufacturing biochips; and an apparatus including a sample ejecting head as precision pipette; and the like, as the other liquid ejecting apparatuses.

What is claimed is:

1. A waste liquid processing device comprising:
a carrier transporting a waste liquid attached thereto;
an attachment portion attaching a liquid cured by irradiation of energy rays to the carrier;
an irradiation portion irradiating the energy rays to the waste liquid attached to the carrier by the attachment portion so as to cure the waste liquid; and
a removal portion removing the waste liquid cured by the irradiation portion from the carrier.

2. The waste liquid processing device according to claim 1, wherein the attachment operation using the attachment portion, the irradiation using the irradiation portion and the removal operation using the removal portion are continuously performed by a transportation operation of the carrier.

3. The waste liquid processing device according to claim 1, wherein an attachment unit including the attachment portion and an irradiation unit including the irradiation portion are provided at different places.

4. The waste liquid processing device according to claim 1, wherein an irradiation unit including the irradiation portion and a removal unit including the removal portion are provided at different places.

5. The waste liquid processing device according to claim 1, wherein the attachment portion is configured to attach the waste liquid onto the carrier by a substantially uniform thickness.

6. The waste liquid processing device according to claim 1, wherein a collection portion collecting the cured waste liquid removed from the carrier by the removal portion is provided in a removal unit including the removal portion.

7. The waste liquid processing device according to claim 3, wherein the carrier is subjected to a transportation operation from the attachment unit to the removal unit through the irradiation unit, is returned to the attachment unit, and is subjected to the same transportation operation,

8. The waste liquid processing device according to claim 1, wherein a waste liquid attachment surface of the carrier is formed of a material to which the cured waste liquid is not adhered.
